(19) United States
(12) Patent Application Publication
(10) Pub. No.: US 2006/0176916 A1
(43) Pub. Date: Aug. 10, 2006

(54) Laser resonator and frequency-converted laser

(76) Inventors: Eckhard Zanger, Seddin (DE); Manfred Salzmann, Berlin (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/542,792

(22) PCT Filed: Dec. 29, 2003
(86) PCT No.: PCT/EP03/14957

§ 371 Date: Mar. 23, 2006

(30) Foreign Application Priority Data
Jan. 23, 2003 (DE) 103 03 657.1
Aug. 20, 2003 (JP) 103 39 210.6

(51) Int. Cl. H01S 3/10

(52) U.S. Cl. 372/28

(57) ABSTRACT

An optically pumped, in particular diode-pumped, continuous solid-state laser produces a primary laser beam whose frequency is converted into the visible or ultraviolet spectral range by means of one or more downstream passive resonators with non-linear crystals. At relatively low cost and complication it is provided that precisely two longitudinal laser modes of approximately equal amplitude are excited in the laser resonator. That achieves a high level of efficiency for the overall system and a very low noise level of the resulting frequency-converted laser beam. In one embodiment of the invention the frequency-converted radiation contains three or more adjacent frequencies. In another embodiment of the invention the frequency-converted laser radiation contains only one single frequency and therefore corresponds to the radiation of a monomode laser.

### CROSS REFERENCE TO RELATED APPLICATIONS

This application is for entry into the U.S. national phase under §371 for International Application No. PCT/EP03/14957 having an international filing date of Dec. 29, 2003, and from which priority is claimed under all applicable sections of Title 35 of the United States Code including, but not limited to, Sections 120, 363 and 365(c), and which in turn claims priority under 35 USC §119 to German Patent Application No. 103 03 657.1 filed Jan. 23, 2003, and German Patent Application No. 103 39 210.6 filed Aug. 20, 2003.

### TECHNICAL FIELD

The present invention pertains to the field of lasers, and more particularly to laser resonators.

### BACKGROUND ART

The invention concerns a laser resonator with an amplification medium arranged therein and a frequency-selective element which is arranged in the laser resonator and which has a frequency-dependent attenuation profile.

Laser resonators of that kind serve to produce a primary laser beam from which a secondary laser beam at a converted frequency can be produced by means of an optically non-linear crystal. Frequency-converted solid-state lasers find many uses in particular in the blue and ultraviolet spectral ranges.

In that respect the non-linear crystal can be arranged either internally, that is to say within the laser resonator, or externally, that is to say outside the laser resonator. As, in the case of internal frequency conversion, the primary laser beam is available within the laser resonator at a substantially higher level of intensity than outside the resonator, internal frequency conversion is expected to be highly efficient. If in contrast frequency conversion takes place outside the laser resonator, then measures must be taken to achieve a conversion efficiency which is adequate for practical uses.

In many variants, precautions are to be taken to reduce non-linear couplings of modes of the laser beam, which would result in the occurrence of unwanted frequencies in the laser beam and thus noise in the intensity of the laser beam.

The methods and apparatuses for frequency conversion which are used in the state of the art and the laser beam noise sources which occur in that case are set forth and discussed hereinafter. The discussion is limited to the case of external frequency conversion which is alone relevant to the present invention.

A known method of enhancing efficiency of external frequency conversion is resonant frequency doubling in a passive resonator (see for example Ashkin et al. “Resonant Optical Second Harmonic Generation and Mixing”, Journal of Quantum Electronics, QE-2, 1966, page 109 and M. Brieger et al. “Enhancement of Single Frequency SHG in a Passive Ring Resonator”, Optics Communications 38, 1981, page 423). In that case a laser beam is coupled into an optical resonator including a mirror and a non-linear crystal, which is resonantly tuned to the frequency of the laser beam. Due to the resonance situation there is an over-increase in the intensity of the laser beam in the resonator and thus an increase in the level of conversion efficiency in the non-linear crystal.

The technology of external resonant frequency conversion has been steadily further developed in recent years and described in numerous publications (see for example U.S. Pat. No. 5,027,361, U.S. Pat. No. 5,552,926, U.S. Pat. No. 5,621,744, U.S. Pat. No. 5,943,350, U.S. Pat. No. 6,088,379, DE19814199, DE19818612, DE10002418 and DE10063977). The level of conversion efficiency achieved with external frequency doubling has in the meantime become up to 90% and in some cases even higher than with internal conversion (see Schneider et al., “1.1W single-frequency 532 nm radiation by second-harmonic generation of a miniature Nd:YAG ringlaser” Optics Letters, Vol 21, No 24, 1996, page 1999).

In U.S. Pat. No. 5,696,780 the laser beam of a diode-pumped solid-state laser is frequency-converted both internally and externally in order to obtain a wavelength in the ultraviolet spectral range. In that situation the laser beam of the internally frequency-doubled laser which is described in U.S. Pat. No. 5,446,749, with a particularly great resonator length, is used to produce by means of an external resonant frequency doubler a laser beam involving four times the frequency of the primary laser beam. As this involves a multimode laser the resonator length of the frequency doubler must be an integral multiple of the resonator length of the laser resonator.

The use of two particularly large resonators, due to the principle involved, results in the equipment being of an unmanageable configuration. In addition the noise level of the frequency-doubled laser beam which is passed to the external frequency doubler is already relatively high as here there is only statistical suppression of the noise. The noise amplitude is not only doubled by the non-linear frequency doubling, but additional frequencies in the particularly disturbing range of between 0 Hz and some MHz are produced due to the effect of difference frequency formation in “mode beating”, that is to say the production of beats due to difference frequency formation in respect of the various laser modes.

The problem of mode beating is described in greater detail hereinafter. It represents a noise source which is always to be found in multimode lasers. That phenomenon is frequently not registered as noise as either it is suppressed by the more severe noise of other noise sources or because the frequencies lie outside the registered range.

For many uses the frequency spectrum of the laser noise plays a crucial part in terms of usability of the laser system. In many uses for example the laser beam is amplitude-modulated by means of an electro-optical modulator. The modulation frequencies used can extend up to several 100 MHz. It is important for the use that the laser noise is as low as possible in the region of the useful frequencies. In contrast laser noise outside that frequency range does not play any part. Beat frequencies in the region of some GHz, as occur due to adjacent laser modes of a laser resonator which is a few centimeters long, are generally immaterial as they are far outside the frequency band which is normally used for modulation. For example, a dual-mode laser with a resonator length of 3 cm involves a frequency spacing in respect of the two laser modes of 5 GHz. Therefore only that one frequency can occur in the noise spectrum, which is harmless for all previously known uses. If however a laser has more than two modes, further beat frequencies are added. The frequencies of longitudinal laser modes in a real laser resonator are not exactly equidistant as the dispersion of optical elements and mode-pulling effects of the active medium displace the frequencies. Therefore the noise spectrum of a laser with more than two modes has a plurality of closely adjacent frequencies corresponding to the mode spacings.

As long as only the fundamental wavelength of the laser is used those frequencies are in the region of some GHz and are therefore harmless in terms of the specified area of uses. If however the laser radiation is frequency-converted by means of a non-linear material, that is to say for example frequency-doubled, then not only the above-mentioned closely adjacent frequencies in the GHz range occur in the noise spectrum of the converted laser radiation, but also the difference frequencies thereof. Those difference frequencies are generally in the range between 0 Hz and a few MHz and are therefore extremely harmful to the stated area of use. Those beats also have the unpleasant property that their frequencies are sensitively dependent on the length of the laser resonator and thus temperature so that a noise spectrum involving different, constantly changing frequencies occurs, which is particularly disadvantageous for the stated uses.

The publication A. Hohla et al., “Biochromatic frequency conversion in potassium niobate”, Optics Letter, Vol. 23, 1998, No. 6, pages 436-438, discloses a laser with a laser resonator in the form of a miniature titanium sapphire laser which can deliver a primary laser beam with two laser modes with a frequency difference of 1.2 GHz. The laser further includes an external ring resonator of bow tie type with curved end mirrors into which the two laser modes are coupled. The external resonator has a temperature-regulated potassium niobate crystal for frequency doubling. Temperature regulation serves to maintain optimum phase tuning of the potassium niobate crystal.

The disadvantage with that arrangement is that fluctuations in external parameters such as the ambient temperature prevent stable, low-noise operation with two laser modes and a constant level of power of the secondary laser beam. A constant power of the frequency converted laser beam is however of great significance in many industrial uses.

The object of the present invention is to provide a laser which permits low-noise and particularly stable external frequency conversion. A further object of the invention is to provide a frequency-converted laser involving a low level of noise and a particularly high level of stability.

### DISCLOSURE OF THE INVENTION

The invention provides a laser resonator and a laser arrangement as described below.

The present invention is based on the realization that the configuration of the laser resonator is of very great significance for stable intensity of the secondary laser beam. Therefore a basic aspect of the invention is a laser resonator for producing the primary laser beam. The configuration of the laser resonator according to the invention is further based on the following realizations:

A laser whose amplification medium (also referred to as the active medium) is markedly shorter than the resonator length and is in the center between the two resonator mirrors has a tendency to two-mode operation. The term two-mode operation basically means the production of two adjacent longitudinal laser modes in the transverse ground state TEM₀₀, that is to say TEM_{00q} and TEM_{00q+1}, wherein q denotes the number of oscillation nodes of the respective mode. The occurrence of higher transverse modes, that is to say for example TEM_{01q}, is avoided by a suitable configuration in respect of the pump light distribution in the active medium and a favorable resonator geometry.

After the oscillation build-up of the two laser modes whose frequencies are closest to the amplification maximum of the active medium the population inversion and therewith the amplification available for further modes fall severely. The population inversion produced in the active medium by the pump beam source is very effectively called up solely by the oscillation build-up of those two modes, that is to say converted into laser radiation, as the interaction zones of the two modes are in mutually complementary relationship.

To express that in simpler terms, the first mode has an antinode where the second has an oscillation node. That complementary use of population inversion by the two modes substantially avoids spatial modulation of the population inversion (“spatial hole burning”).

However, further modes can periodically start to oscillate with such an arrangement, without additional measures. Whether and how many further modes begin to oscillate depends on the band width of the amplification medium, the pump power and the resonator length. The greater the pump power and the greater the resonator length, the correspondingly greater the number of further modes which can begin to oscillate as in that way both the residual amplification available for the additional modes and also the number of additional modes in the amplification band width rise.

Even with a very low level of pump power and a very short resonator the situation frequently occurs where three modes begin to oscillate. That is the case for example when the frequency of a mode is approximately in the center of the amplification range and as a result the two adjacent modes experience approximately the same amplification.

An underlying idea of the present invention is therefore to avoid the occurrence of more than two modes in the laser resonator as the occurrence of a single further mode, in external frequency conversion, already leads to instabilities in respect of the frequency-converted output power and the above-mentioned “mode-beating” and thus increased noise. In accordance with the invention that is achieved in that two adjacent longitudinal modes involving the same or approximately the same intensity are caused to oscillate in the resonator.

Therefore the laser resonator according to the invention includes an amplification medium arranged therein and a frequency-selective element which is arranged in the laser resonator and which has a frequency-dependent attenuation profile. The frequency-selective element, in terms of the frequency dependency of the attenuation profile, and the laser resonator, in terms of its optical length, are tuned or are adapted to be tunable in such a way that, with an adjustable optical two-mode length of the laser resonator, a laser beam with precisely two adjacent longitudinal laser modes of the same or approximately the same intensity can be coupled out of the laser resonator.

In accordance with the invention, a low-noise two-mode operation is made possible by means of suitable tuning of the frequency-selective element and the resonator length. With a predetermined attenuation profile the length of the laser resonator is to be so adjusted in accordance with the invention that two adjacent longitudinal laser modes of the same or approximately the same intensity are coupled out of the laser resonator. That optical length of the laser resonator is referred to as the optical two-mode length. It is dependent on the respective ambient temperature, the ambient air pressure and a predetermined frequency dependency of the attenuation profile of the frequency-selective element. The term “optical length” takes account in that respect of the influence of the refractive index.

The laser resonator achieves a particularly high level of stability, with a regulator provided in accordance with the invention. In a first alternative it has a first regulator which is adapted to control a change in optical length of the laser resonator in dependence on an input signal. The first regulator is adapted to effect control in such a way that the primary laser beam is permanently coupled out with the same or approximately the same intensity for the two laser modes. The input signal is dependent on the difference in intensity or the energy or the power of the two laser modes.

Alternatively there is additionally provided a second regulator which is adapted to control a change in the attenuation profile of the frequency-selective element in dependence on an input signal such that the primary laser beam can be continuously coupled out at the same or approximately the same intensity of the two laser modes. The input signal is dependent on the difference in intensity of the two laser modes.

As a further alternative the laser resonator according to the invention has a third regulator which is adapted to control both the optical length of the laser resonator and also the attenuation profile of the frequency-selective element in dependence on an input signal, wherein the third regulator is additionally adapted to effect control in such a way that the primary laser beam can be continuously coupled out at the same or approximately the same intensity of the two laser modes. The input signal is dependent on the difference in the intensity of the two laser modes.

The laser resonator according to the invention permits a stable two-mode operation. The occurrence of further modes can be successfully suppressed by means of the frequency-selective element, in a wide power range. In comparison therewith, the suppression of unwanted modes in multimode lasers in accordance with the state of the art, for example in U.S. Pat. No. 5,960,015, is achieved only in a limited power range. As a consequence of the more effective suppression of further modes, the laser according to the invention has an improved noise characteristic over multimode lasers according to the state of the art.

The laser resonator according to the invention is distinguished in that two adjacent laser modes can be permanently coupled out at the same or approximately the same intensity.

In a preferred embodiment of the laser resonator according to the invention the amplification medium has an amplification profile with a center frequency ν₀, at which the amplification profile is at a maximum. In this embodiment, with the optical two-mode length of the laser resonator, the frequencies of the two adjacent longitudinal laser modes are disposed symmetrically or approximately symmetrically around the center frequency ν₀.

An only approximately symmetrical arrangement provides that the two adjacent laser modes occur at only approximately equal intensity in the laser beam. That however is no consequence in terms of the intensity of the resulting laser beam as the sum of the intensities of the two modes is unchanged relative to the case of equal intensity. It is only when an external passive resonator is operated for frequency conversion with the laser resonator according to the invention that the intensity ratio of the two adjacent laser modes has an effect on the overall power of the frequency-converted laser beam. If a variable division factor κ(0 . . . 1) is defined, in accordance with which the constant overall power P_{f} is divided to afford the powers P₁ and P₂ of the two laser modes, in accordance with:
P₁=κP_{f}
P₂=(1−κ)P_{f}
then the following follows for the frequency-doubled power Pₛ in a first approximation:
Pₛ=γ(P₁²+4P₁P₂+P₂²)
Pₛ=γ(−2(κ−0.5)²+1.5)P_{f}²
wherein γ represents the conversion coefficient. Accordingly the frequency-doubled power Pₛ assumes a maximum at κ=0.5, that is to say with symmetrical division of the power. Therefore the frequency-doubled power or a change in the frequency-doubled power is a particularly suitable input signal for the regulator of the laser resonator according to the invention.

In a preferred embodiment of the invention the first or the third regulator produces a control signal and outputs the control signal to a first adjusting member which is adapted to change the optical length of the laser resonator in dependence on the applied control signal.

Preferably the first adjusting member is adapted to change the temperature of the laser resonator. That variant is structurally simple. Regulation of the temperature is on its own often already sufficient to regulate the optical length of the laser resonator or the preferred frequency of the frequency-selective element or both. In a further embodiment of the invention therefore the first adjusting member is additionally adapted to change the temperature of the frequency-selective element.

In a further embodiment the second regulator produces a control signal and outputs the control signal to a second adjusting member which is adapted to change the temperature of the frequency-selective element.

Preferably, a linear frequency-selective element, in particular an etalon or a combination of a plurality of etalons, is used as the frequency-selective element. The etalon can be so designed that its surface normal includes with the direction of the laser beam an angle which is different from zero, in which respect the faces of the etalon can be uncoated. That involves an angle-tunable etalon. In particular at least one coupling-out mirror in the form of an etalon is used, whose degree of coupling-out, due to the etalon action, is frequency-dependent and which thereby suppresses the unwanted modes. Such an etalon can be tuned for example by changing the temperature. With correct choice in respect of the thickness and the coating of the etalon, a stable two-mode form of operation is possible over a wide power range from the laser threshold to several watts output power. The configuration of the laser with a coupling-out mirror in the form of an etalon is distinguished inter alia by a particularly low level of complication and expenditure and a high degree of efficiency. The invention however is not limited to that specific arrangement. Rather, other frequency-selective elements such as for example a birefringent filter or an angle-tunable etalon or a combination of such elements can also be used in accordance with the invention. Hereinafter therefore the etalon is only referred to as representative of one of the frequency-selective elements to be considered.

At any event the etalon has a preferred frequency which is tuned to the center frequency ν₀ of the amplification profile. The band width of the etalon is so selected that adequate attenuation of all unwanted laser modes takes place.

The laser arrangement according to the invention, besides the laser resonator according to the invention, includes an external passive resonator for frequency conversion of a primary laser beam emanating from the laser resonator. Dispensing with the use of non-linear materials for frequency conversion within the laser resonator makes it possible to afford a frequency-converted laser with stable conditions, in particular with a stable two-mode operation and a low noise level. In particular it is possible to provide that the noise spectrum of the frequency-converted laser beam only includes beat frequencies which are greater than or equal to the frequency spacing of the two adjacent longitudinal laser modes of the primary laser beam and that the effective value of the noise of the frequency-converted laser beam in the frequency range below the lowest beat frequency is at most 0.2% of the mean output power.

Separation of the laser source and the passive resonator as a frequency converter also involves division of the tasks for the laser resonator and the passive resonator, namely the production of a stable low-noise primary laser beam in the former and efficient frequency conversion in the latter. The separation of laser source and frequency converter such as for example a frequency doubler therefore affords the designer additional degrees of freedom in regard to separate optimization of the two parts. Thus for example the length of the non-linear crystal can be optimized solely for the requirements of frequency conversion without that having an effect on the laser source. Operational limitations such as for example a maximum permissible pump power for low-noise operation, as are to be observed in part in relation to internal frequency doubling, cease to apply in regard to external frequency conversion. Separate optimization of laser source and frequency converter therefore makes it easier for the designer to fulfill the demands with which he is faced.

As the power of the primary laser beam does not change if the optical length of the laser resonator deviates from the optimum, no input signal, for example in the form of a fault signal, for the regulator of the laser resonator according to the invention, can be derived from that parameter.

Therefore, a particularly preferred embodiment of the laser arrangement according to the invention has a first measuring means which is arranged and adapted to produce and output a first measurement signal dependent on the intensity of the secondary laser beam. A further embodiment has an evaluation unit which is connected on the output side of the first measuring means and which is adapted to output from the first measurement signal a fault signal which is dependent on the deviation of the optical resonator length from the optimum length, that is to say the optical two-mode length, and includes an item of directional information, that is to say for example it is positive in relation to an excessively short resonator length and negative in relation to an excessively long resonator length. In a particularly preferred feature the fault signal is passed as an input signal to the first, second or third regulator. The background to these embodiments is that the power of the frequency-converted laser beam assumes a maximum at the optimum resonator length. Detection of the frequency-converted intensity can therefore furnish a signal from which an input signal for the regulating circuit can be obtained. As a result the external passive resonator for frequency conversion additionally serves as a kind of detector for the mode structure of the laser resonator. The first measurement signal is then at a maximum when the mode structure is symmetrical around the center frequency and thus optimum for the laser operation.

In particular the external passive resonator can be designed for frequency doubling. In the case of frequency doubling, by virtue of the properties of non-linear crystals, the primary laser radiation which in accordance with the invention includes two adjacent frequencies ν₁ and ν₂ involves the additional production of three further frequencies, namely the doubled frequencies 2ν₁ and 2ν₂ as well as the sum frequency ν₁+ν₂ of the two original frequencies. The frequencies of the two laser modes of the primary laser beam are so closely adjacent that they are within the acceptance range for phase tuning in the non-linear crystal. For sum frequency mixing there is then also phase tuning with a conversion coefficient which is greater by a factor of 4 (see for example V. G. Dmitriev, G. G. Gurzadyan, N. Nikogosyan, “Handbook of Nonlinear Optical Crystals”, Springer Series in Optical Sciences, Vol. 64, ISBN 3-540-65394-5). The intensities of the three frequencies are therefore in a ratio of 1:4:1.

In comparison with conventional multimode laser radiation the frequency-converted laser beam according to the invention is distinguished by two highly advantageous properties: on the one hand the three contained frequencies are exactly equidistant with a frequency spacing of Δν=ν₂−ν₁, while on the other hand ⅔ of the overall power are combined in the center frequency of the frequency-doubled laser beam. The advantageous effect of those properties is of significance in particular when two external passive resonators are connected in succession, as will be described in greater detail hereinafter.

If the optical length of the external passive resonator corresponds to an integral multiple of the optical length of the laser resonator, it is possible to provide in the case of a two-mode laser that the external passive resonator is resonant for both frequencies of the primary laser beam so that it is possible to achieve the same level of efficiency in frequency conversion as with a monomode laser. In contrast thereto, in an arrangement in accordance with U.S. Pat. No. 5,696,780 in which a multimode laser with typically 100 modes is externally frequency-converted, resonance is achieved only for a part of the laser modes in the passive resonator as the frequency spacing of the modes changes due to dispersion in the laser resonator and in the passive resonator in accordance with different non-linear interrelationships. That means that the level of efficiency which can be achieved with such an arrangement is lower. Because of the above-mentioned “mode beating”, the frequency-converted laser beam of an arrangement in accordance with U.S. Pat. No. 5,696,780 has a plurality of beats in the low-frequency range, whose amplitudes and frequencies change in a complicated manner with ambient parameters such as air pressure and temperature.

In a further configuration of the laser according to the invention, for frequency conversion purposes it includes at least two external passive resonators which are connected in succession in such a way that the primary laser beam can be coupled into the first external passive resonator and the frequency-converted laser beam issuing from the first external passive resonator can be coupled for further frequency conversion into the second external passive resonator. If the external passive resonators are each designed for frequency doubling, it is possible with that configuration to achieve a laser beam of a frequency which is four times the primary laser beam.

In order to achieve a maximum possible level of conversion efficiency, in a first configuration of the two external passive resonators the optical lengths of the two resonators can correspond to a integral multiple of the optical length of the laser resonator. If the non-linear crystals of the external passive resonators are designed for frequency doubling, that provides for example that resonance occurs in the second external passive resonator for all three frequencies of the frequency-doubled laser beam. Frequency doubling and sum frequency mixing produces a “frequency-quadrupled” laser beam with five adjacent frequencies at the frequency spacing Δν=ν₂−ν₁. No troublesome low-frequency noise can occur due to beats, because of the exact equidistance. The first of the above-mentioned highly advantageous properties therefore provides that a multimode laser beam can be multiplied in frequency with a high level of efficiency without troublesome beat frequencies occurring.

In some uses of ultraviolet laser radiation such as for example in lithography and confocal microscopy it is however of crucial significance for the laser beam to contain only one single frequency. To achieve that, in an alternative configuration of the two external passive resonators therefore the optical length of the second external passive resonator is adjusted in such a way that it differs markedly from an integral multiple of the optical length of the laser resonator.

In the case of frequency-doubling non-linear crystals in the passive resonators this means for example that the optical length of the second passive resonator is so dimensioned that resonance occurs only for the mean frequency ν₁+ν₂ of the frequency-doubled laser beam produced by the first passive resonator. As a result, only one of the three frequencies present is doubled and the newly produced converted laser beam only still contains the one frequency 2(ν₁+ν₂).

In this case the passive resonator additionally has the action of a narrow-band filter which suppresses unwanted frequencies. If the power of the laser beam coupled into the second passive resonator were distributed uniformly to the three frequencies, then only ⅓ of that power would circulate in the resonator. Because of the quadratic dependency of the doubling process the conversion efficiency would drop to 1/9 of the value which is to be found in the above-described embodiment in which all three frequencies are resonant. As in the present case the power circulating in the resonator only falls to ⅔, the conversion efficiency is only reduced to 4/9. The second of the above-mentioned highly advantageous properties therefore provides for a level of conversion efficiency which is four times higher if the secondary modes are suppressed by means of the second passive resonator for the purposes of monomode operation.

The specified configurations of the two external passive resonators therefore involve two laser sources, of substantially identical design, for ultraviolet laser radiation, of which the first configuration affords multimode laser radiation with a high level of efficiency while the second configuration affords monomode laser radiation with 44% of the efficiency of the first configuration. The two embodiments only differ in a slightly different optical length in respect of the second passive resonator. It is therefore even possible for one configuration to be converted into the other by the introduction of an optical element which maintains the beam geometry and permits a change in the optical travel length, thereby to provide a switch between multimode laser radiation and monomode laser radiation.

In a further configuration of the invention the laser with external frequency conversion also includes a pump light source as well as a regulating circuit with a detector for detecting high-frequency power fluctuations and an adjusting member for acting on the pump light source in such a way that undamped oscillations in the laser power are suppressed. That is described in greater detail hereinafter.

In an embodiment of the present invention the primary laser beam of a solid-state laser is coupled in the two-mode operation into an external passive resonator in order to produce a frequency-converted laser beam. The passive resonator is desirably a ring resonator (M. Brieger et al. “Enhancement of Single Frequency SHG in a Passive Ring Resonator”, Optics Communications 38, 1981, page 423) in order to avoid direct reflection of the primary laser beam back into the laser resonator as that generally leads to instabilities. However even a ring resonator is not reaction-free as the optical elements in the resonator and in particular the non-linear crystal can scatter the laser light in various directions. The light which is scattered in opposite relationship to the incoming radiation direction is amplified by resonance over-increase in the resonator and passes back into the laser resonator in the form of a directed beam. As long as the spacing between the laser resonator and the passive resonator is constant and backscatter behaves strictly linearly with the laser power, no instabilities occur as a result of this.

In the case of passive resonators with a non-linear crystal however power-dependent, non-linear backscatter effects can occur. That manifests itself in that the resonance frequency of the passive resonator changes with the power of the light wave circulating in the resonator. The change in the resonance frequency in turn leads to a change in the power as the resonance condition changes. That phenomenon is utilized in the method of “additive pulse mode locking” in order to bring about pulse operation by mode coupling in a continuously pumped solid-state laser such as for example a titanium sapphire laser (see W. Koechner, “Solid State Laser Engineering”, Springer Series in Optical Sciences, page 515, ISBN 3-540-60237-2). In the present invention however that phenomenon can lead to unwanted oscillation. In an optically pumped solid-state laser the dynamics of the excitation process can lead to a resonance behavior, the so-called relaxation oscillation. This normally involves a damped oscillation as long as excitation of the laser medium does not occur in pulse form. That damped relaxation oscillation can give rise to an undamped oscillation with a modulation depth of up to 100% if there is a non-linear reaction of the above-described kind and the spacing between the laser resonator and the passive resonator is such that feedback occurs due to a suitable phase relationship. The frequency of the oscillation which occurs corresponds to the relaxation resonance and is typically in the frequency range of between 100 kHz and 1 MHz, depending on the active laser material used and the pump power.

In the present invention the occurrence of that undamped oscillation would represent an unwanted event. In principle that could be avoided by making the spacing between the laser resonator and the passive resonator such that the feedback becomes a negative feedback and as a result the undamped oscillation again becomes a damped oscillation. For that purpose however the spacing must be permanently maintained precisely at fractions of the wavelength, which would only be possible with a complicated and expensive electronic regulating system with a piezoelectric adjusting member.

The present invention involves choosing a less complicated and expensive way of preventing the described oscillations. As has already been mentioned hereinbefore in the discussion of noise sources, the noise caused by the damped relaxation oscillation of a diode-pumped solid-state laser can be reduced by means of electronic negative feedback (see Harab et al., “Suppression of the Intensity Noise in a Diode-pumped Neodymium:YAG Nonplanar Ring Laser”, IEEE Journal of Quantum Electronics, Vol. 30. No. 12 1994, p2907). In that case the high-frequency power fluctuations of the primary laser radiation are converted into an electrical signal by means of a photodetector. That signal is electronically amplified and, after possible frequency response and phase correction, added to the operating current of the laser diode or the laser diode array.

In principle that is also possible with other pump light sources if the pump light power reacts sufficiently quickly to the operating current. That negative feedback method was used in the above-mentioned publication exclusively for reducing noise. In the present invention however it is used to avoid unwanted oscillation of the laser power which arises out of the co-operation of the relaxation resonance of the laser-active medium and the non-linear optical reaction of a positive resonator.

### BRIEF DESCRIPTION OF THE DRAWINGS

Further features, properties and advantages of the present invention will be apparent from the description hereinafter of embodiments by way of example, with reference to the Figures in which:

FIG. 1 shows a first embodiment for the laser according to the invention with only one frequency conversion stage,

FIG. 2 shows a second embodiment for the laser according to the invention with two frequency conversion stages,

FIG. 3 shows a third embodiment for the laser according to the invention with a regulating circuit for stabilizing the two-mode operation,

FIG. 4 shows a fourth embodiment for the laser according to the invention with a regulating circuit for damping relaxation oscillations,

FIG. 5 shows a diagrammatic illustration of the frequency dependency of the various elements in the laser resonator,

FIG. 6 shows a diagrammatic illustration of the power of the primary and the frequency-converted laser beam in dependence on the temperature of the laser resonator shown in FIG. 3,

FIG. 7 shows a diagrammatic illustration of the frequency spectrum of primary and frequency-multiplied laser beams in an embodiment with a multi-frequency resulting laser beam,

FIG. 8 shows a diagrammatic illustration of the frequency spectrum of primary and frequency-multiplied laser beams in an embodiment with a single-frequency resulting laser beam, and

FIG. 9 shows oscilloscope recordings of relaxation oscillations after an interference pulse with a) coupled frequency doubler, b) without frequency doubler, without electronic negative feedback, and c) with electronic negative feedback.

### DETAILED DESCRIPTION OF THE INVENTION

The invention provides in particular an optically pumped, specifically a diode-pumped, continuous solid-state laser with external frequency conversion. A laser crystal as an active medium in a laser resonator produces a primary laser beam with a fundamental wavelength, from which one or frequency-converted laser beams are produced by means of external resonant frequency conversion. A high level of overall efficiency and a very low noise level are achieved with relatively little complication and expenditure by exciting precisely two longitudinal laser modes in the laser resonator. In an embodiment of the invention the frequency-converted radiation includes three or more frequencies. In another embodiment of the invention the frequency-converted laser radiation contains only one single frequency and therefore corresponds to the radiation of a monomode laser. That will be discussed in detail in the description hereinafter of the embodiments by way of example.

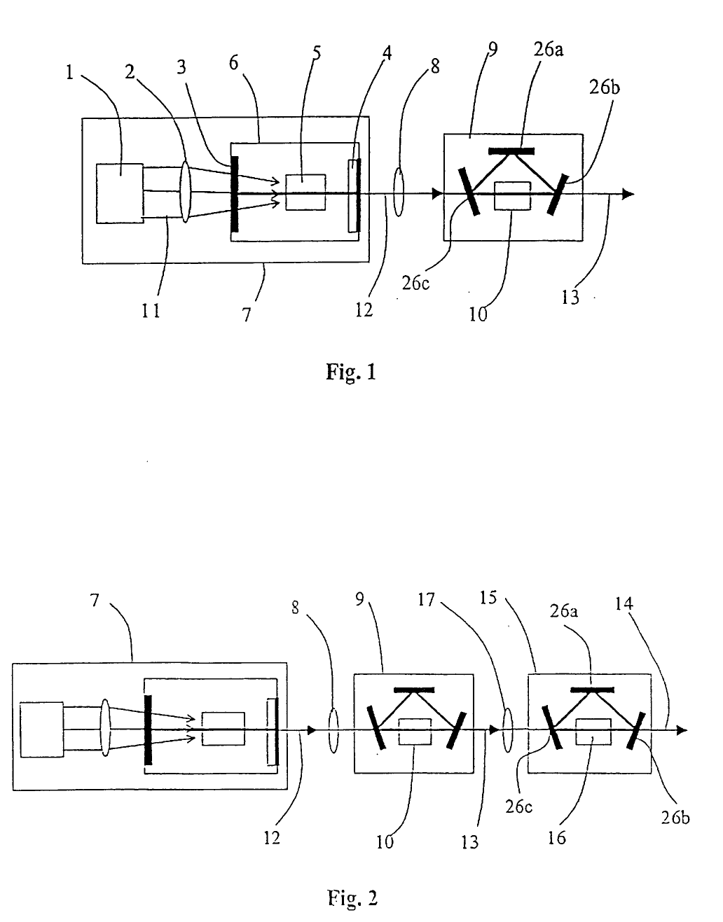

The embodiment shown in FIG. 1 has a two-mode laser 7, an optical transfer arrangement 8 and a frequency doubling unit 9. The two-mode laser 7 includes a laser diode 1 as a pump light source for emitting a pump light beam 11, an optical focusing arrangement 2 which for the sake of simplicity is shown as a simple lens, and a laser resonator 6 with a laser crystal 5 arranged approximately centrally therein, a coupling-in mirror 3 for coupling in the pump light beam and a coupling-out mirror 4 for coupling out the laser beam.

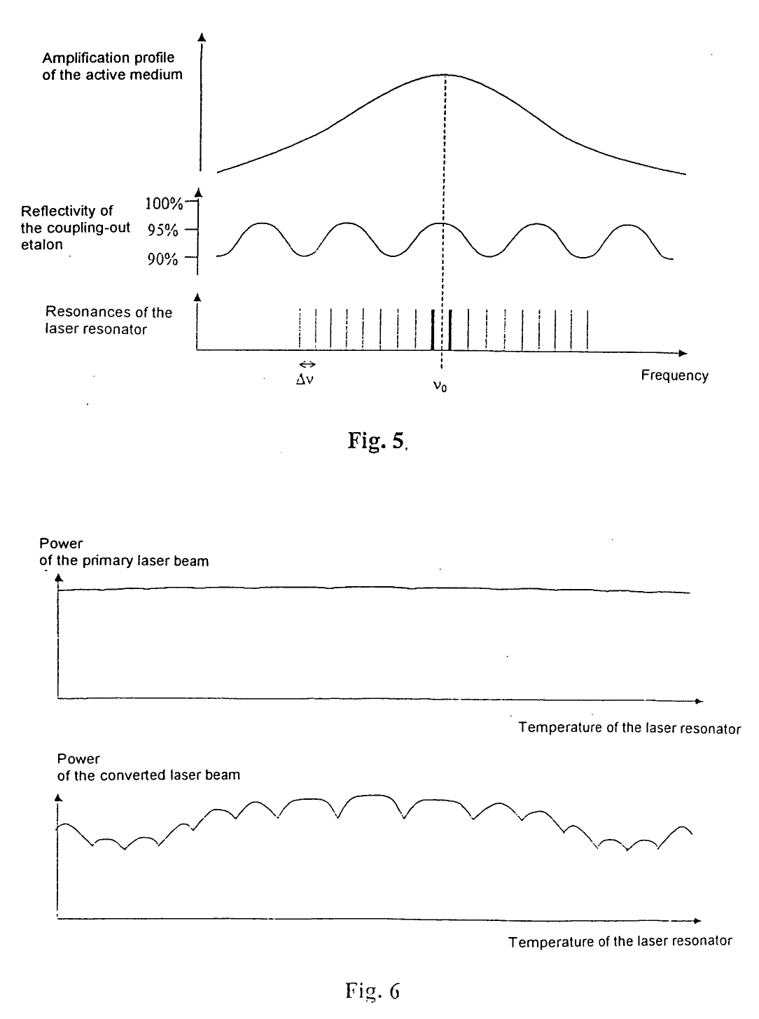

The pump light beam 11 produced by the laser diode 1 is focused into the laser crystal 5 by means of the optical focusing arrangement 2 by way of the coupling-in mirror 3. The laser crystal used is preferably the material Nd:YVO₄ as it has a high level of efficiency and produces polarized laser light. The coupling-in mirror 3 is transparent for the wavelength of the pump radiation and highly reflective for the fundamental wavelength of the laser. The coupling-out mirror 4 is in the form of an etalon and is therefore also referred to hereinafter as the coupling-out etalon. The coupling-out etalon 4 is a plane-parallel plate of quartz, which is uncoated on the inwardly directed face and which on the outwardly directed face is coated to be partially reflective for the fundamental wavelength of the laser. The degree of reflection of that layer is selected to be lower by the Fresnel reflection of the inside than the value which is optimum for the typical operating parameters of the laser. The reflectivity of the coupling-out etalon then has a frequency dependency which is illustrated similarly as in the central curve in FIG. 5 and which, with a suitably selected thickness, adequately suppresses the unwanted laser modes. With an optical resonator length of about 30 mm, a thickness of the coupling-out mirror of 2 mm and a degree of reflection of about 90%, a two-mode operation up to several watts output power was achieved.

The optical transfer arrangement 8 shown in FIG. 1 in the form of a simple lens passes the primary laser beam 12 into the frequency doubler 9 under mode tuning conditions. The frequency doubler is diagrammatically shown in the form of a passive ring resonator with three mirrors 26a, 26b and 26c and a non-linear crystal 10, further details such as for example resonator length stabilization having been omitted for the sake of simplicity. The materials which can be used for the non-linear crystal are for example LiNbO₃, KTP, LBO or BBO. Apart from the optical resonator length which is set to an integral multiple of the length of the laser resonator, the precise design configuration of the passive resonator is of secondary significance to the present invention. The frequency-doubled laser beam produced in the non-linear crystal 10 issues in the form of a resulting laser beam 13 which is generally in the visible spectral range. Thus for example with Nd:YVO₄, it is possible to produce the wavelengths 532 nm or 670 nm. In particular, with the described arrangement, with a pump power of the laser diode of 4 W at 808 nm, it is possible to achieve a power in respect of the primary laser beam of 2 W at 1064 nm and a power in respect of the frequency-doubled beam of more than 1 W at 532 nm. The efficiency when producing the frequency-doubled laser beam from the pump beam is in that case more than 20%.

A second embodiment of the invention (FIG. 2) has two external passive resonators 9, 15 as frequency conversion stages. In the downstream-arranged second passive resonator 15, a laser beam at four times the frequency of the primary laser radiation is produced by means of a suitable non-linear crystal 16 from the frequency-doubled laser beam produced in the first passive resonator. In order to achieve the highest possible level of conversion efficiency the optical length of the second passive resonator 15 is such that resonance occurs for all three frequencies of the frequency-doubled laser beam. That embodiment is described in greater detail hereinafter with reference to FIG. 2.

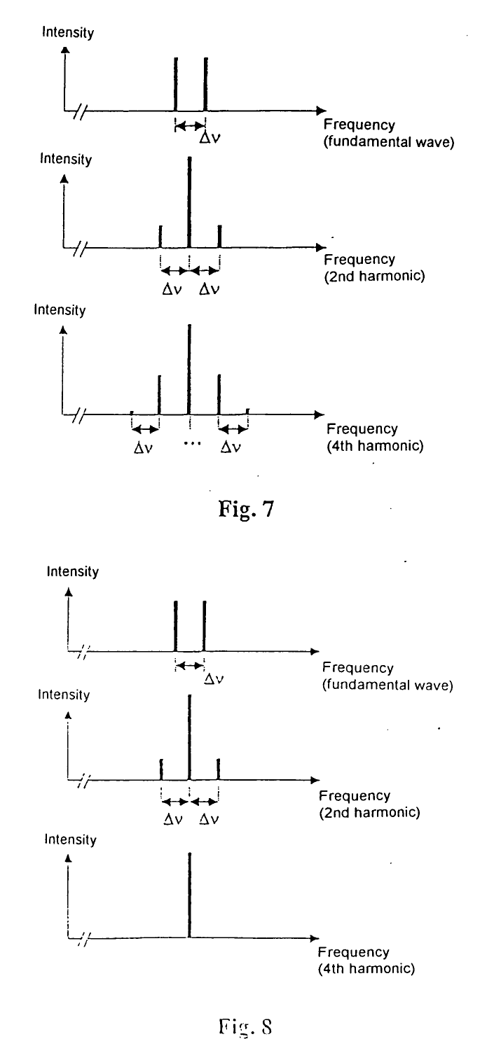

The laser shown in FIG. 2 differs from the laser shown in FIG. 1 only in that there are a second optical transfer arrangement 17 and a second external passive resonator 15 which are arranged downstream of the first external passive resonator. The frequency-doubled laser beam 13 is coupled into the second frequency doubling unit 15 by way of the second optical transfer arrangement 17. The second frequency doubling unit 15, like the first frequency doubling unit, includes a non-linear crystal 16, by means of which a frequency-quadrupled laser beam 14 is produced. The resulting laser beam 14 is then usually of a wavelength in the ultraviolet spectral range. When using the material Nd:YVO₄ it is possible for example to produce the wavelengths 266 nm or 335 nm. The detailed spectral properties of the resulting laser beam depend on the precise design configuration of the second frequency conversion stage. The first frequency doubling stage 9 is preferably so designed that it is resonant for both frequencies of the primary laser beam. That is achieved by the optical resonator length of the resonator 9 being tuned to an integral multiple of the optical resonator length of the laser resonator 6. The frequency spectrum of the second harmonic 13 is shown in FIG. 7 (at the center). The spectrum comprises a main line with two satellites with a respective level of intensity which is lower by a factor of 4. The second frequency doubling stage 15 can now be designed optionally in two configurations.

In the first configuration the second frequency doubling stage 15 is of such a design that it is resonant for all three frequencies of the second harmonic. That can be achieved by the optical resonator length of the resonator 15 also being tuned to an integral multiple of the optical resonator length of the laser resonator 6. In that case the total available power of the second harmonic 13 is used to produce the fourth harmonic 14 and thus the maximum possible efficiency is achieved. In that case the frequency spectrum of the fourth harmonic contains five frequencies as shown in FIG. 7 (bottom). In addition the noise spectrum of the frequency-quadrupled laser beam does not contain any beat frequencies which are lower than the frequency spacing of the longitudinal modes of the primary laser beam. That configuration is optimum for uses in which a high level of output power or efficiency is required but the frequency spectrum in detail does not play any part.

For uses which require less power but a single-frequency laser beam, the embodiment shown in FIG. 2 can be modified in such a way that only the main line of the second harmonic is used to produce the fourth harmonic. For that purpose the resonator length of the second passive resonator 15 is so tuned that it is markedly different from an integral multiple of the resonator length of the laser resonator 6. Thus the second passive resonator 15 can only still be resonant in relation to one of the three frequencies of the second harmonic and thus can also only efficiently double one of the three frequencies. Desirably the electronic resonator length stabilization action of the second passive resonator 15 is such that it stabilizes only to the main line but not to the satellite lines in order to achieve the highest possible level of efficiency for that situation. The frequency spectrum of primary, frequency-doubled and frequency-quadrupled laser beam for this embodiment is diagrammatically illustrated in FIG. 8. The frequency spectrum of the resulting fourth harmonic of this embodiment of the invention contains only one single frequency and accordingly does not differ from the frequency spectrum of a frequency-quadrupled monomode laser. The noise spectrum of the frequency-quadrupled laser beam of this configuration does not contain any beat frequencies which arise out of the superimposition of adjacent frequencies.

It is desirable for the two-mode operation to remain permanently guaranteed even upon a change in ambient parameters such as temperature and pressure. As the frequency-dependent elements in a laser are generally sensitively dependent on such ambient parameters they must be stabilized by regulating loops, as is also generally usual in relation to monomode lasers. In contrast to multimode lasers such as for example in accordance with U.S. Pat. No. 5,446,749 or U.S. Pat. No. 5,696,780 in which the demands in regard to noise and power stability are lower and fluctuations in the number of modes are concealed in the statistics of about 100 modes, a fluctuation in the number of modes is not wanted in the present invention as the properties of the laser alter markedly if the number of modes increases for example from two to three. Admittedly the power of the primary laser beam which is coupled out of the laser resonator changes only immaterially if the number of modes changes but the power of the light wave circulating in the passive resonator and thus the power of the frequency-converted laser beam are heavily dependent on the number of modes. Due to “mode pulling” and dispersion effects in respect of the laser-active medium in the laser resonator and of the non-linear crystal in the passive resonator, the equidistance which is otherwise present in respect of the frequencies of the resonator modes is cancelled. In order to achieve a level of efficiency of frequency conversion which is as high as possible, the optical resonator length of the passive resonator is so set that the frequencies of the two active laser modes are resonant as exactly as possible. If now further laser modes occur, that will no longer exactly succeed. In that way the resonance over-increase in the passive resonator is reduced and consequently the efficiency of the frequency conversion is decreased. On the one hand that behavior requires measures for stabilizing the output power of the laser as the power fluctuations which are otherwise to be expected are unacceptable, while on the other hand it is precisely that behavior that first affords the possibility of obtaining a correction signal from the variation in the frequency-converted output power or the power circulating in the passive resonator, which can be used for a regulating loop for stabilizing the frequency-determining elements. In the known procedures for the electronic stabilization of monomode lasers, for example in accordance with U.S. Pat. No. 5,107,511 or U.S. Pat. No. 5,144,632 the markedly perceptible variation in laser power upon detuning of one of the frequency-determining elements, such as for example an etalon, is used to obtain a correction signal for regulation of the adjusting element. The laser power decreases by up to 20% if for example the etalon is detuned in relation to the optimum setting. In the present invention the power of the primary laser beam produced in the laser resonator does not afford such a clear criterion for etalon adjustment or in respect of the resonator length. The variation in the laser power when tuning the etalon remains markedly below 1% as at least two laser modes are active at any time. Attenuation of one laser mode by an unfavorable etalon setting causes at the same time a strengthening of the other laser mode. If further unwanted laser modes are added the behavior becomes even more indifferent. The desired condition of precisely two laser modes whose frequencies are symmetrical with respect to the maximum of the amplification of the active medium is not distinguished by a maximum or minimum in respect of the power of the primary laser beam. As long as the primary laser radiation involving the fundamental wavelength represents the useful radiation, there is in that respect also no need whatsoever for stabilization measures as power stability, noise and overall efficiency present good values. It is only frequency conversion that involves the need and at the same time also the possibility of stabilization measures insofar as the passive resonator is used as a kind of detector for the mode structure of the primary laser beam.

In U.S. Pat. No. 4,398,293 the change in a beat frequency is used to stabilize the wavelength of a laser. It will be noted in this respect however that this involves the beat frequency between two modes with a different polarization condition but an equal longitudinal mode number. Therefore the frequency spacing of those modes at about 300 kHz is very short and can be evaluated with standard electronic components. In contrast, with mode spacings of some GHz purely electronic evaluation of beat frequencies is very complicated and expensive and is therefore not used in the present invention.

For the desired two-mode operation it is necessary for the frequency-determining elements in the laser resonator to be synchronized. In that respect a preferred frequency of the etalon is tuned to the frequency ν₀ of the maximum amplification of the active medium. The optical length of the laser resonator is so tuned that the frequencies of the two active modes are symmetrical with respect to the central frequency ν₀. In order permanently to guarantee the two-mode operation, active regulation is helpful as the optical length of the laser resonator is sensitively dependent on ambient parameters such as pressure and temperature. Both the resonator length and also the etalon preferred frequency can be controlled for example by means of active temperature regulation. If the temperature dependency of the frequencies of the laser resonator and the etalon are very different, which can always be achieved by a suitable choice for the materials for the resonator body and the etalon, and if the etalon is in heat-conducting relationship with the resonator body, both elements can be regulated by a common temperature with only one regulating loop. In that case the common temperature is firstly roughly set in accordance with the element having the lower temperature dependency, for example the etalon. A given selection of the active laser modes is afforded on the basis of that setting. Fine setting of the temperature is now effected with regard to symmetrization of the active modes in relation to the center frequency ν₀.

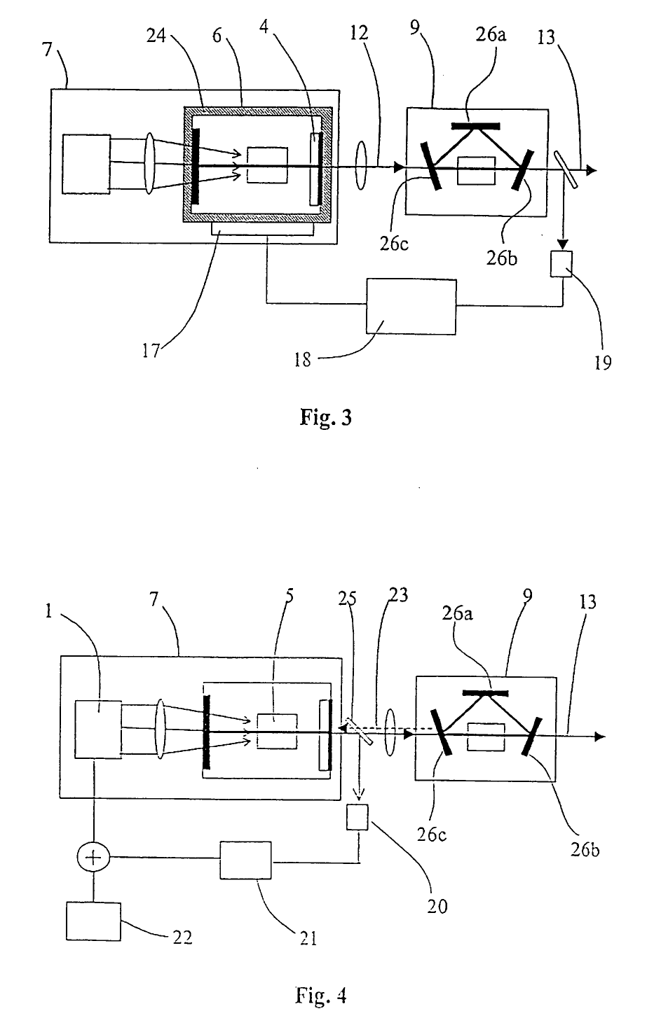

An embodiment with which the two-mode operation is guaranteed even under changing ambient conditions by means of such a regulating loop is shown in FIG. 3. It differs from the embodiment of FIG. 1 only by the regulating loop. An adjusting element 17, preferably a Peltier element, is mounted to the laser resonator 6 in order thereby to control the common temperature of the spacing-determining material 24 of the laser resonator 6 and of the coupling-out mirror 4 which is in the form of the etalon. An electrical signal which is proportional to the power of the resulting laser beam 13 is produced with a detector 19. FIG. 5 diagrammatically shows the frequency dependency of the various elements in the laser resonator 6. The upper curve shows the amplification profile of the laser crystal 5, the central curve shows the reflectivity of the coupling-out etalon 4 and the lower curve shows the resonances of the laser resonator 6. The preferred frequencies of the coupling-out etalon 4 are those frequencies at which the reflectivity of the coupling-out etalon 4 is at a maximum and thus the resonator losses are at a minimum. In order to achieve the two-mode operation, a preferred frequency of the coupling-out etalon 4 must approximately coincide with the center frequency ν₀ of the active material and the frequencies of two adjacent laser modes in accordance with the lower curve in FIG. 5 must be approximately symmetrical with respect to ν₀. As both conditions have to be observed only with a limited degree of accuracy, it is sufficient to use a single parameter, namely the common temperature of the laser resonator 6 and the coupling-out etalon 4, for tuning purposes. For that purpose the materials are so selected for example that the laser modes of the laser resonator 6 are displaced substantially more quickly with temperature than the preferred frequencies of the coupling-out etalon 4. The common temperature of the laser resonator 6 and the coupling-out etalon 4 is firstly roughly set in accordance with the first criterion so that therefore a preferred frequency of the etalon is coincident with ν₀. Then the temperature is only slightly corrected so as to satisfy the second criterion, that is to say two laser modes which are symmetrical with respect to ν₀. The temperature change necessary for that purpose is so slight that the first criterion is still satisfied with a sufficient level of accuracy. If the common temperature is changed over a wide range, the power of the frequency-converted laser beam behaves approximately as shown in the lower curve in FIG. 6. In contrast to the power of the primary laser beam, as is shown in the upper curve, that curve has marked maxima. Therefore that measurement parameter is suitable as a correction signal for a regulator 18 which regulates the common temperature of the laser resonator 6 and the coupling-out etalon 4 so that maximum power of the resulting frequency-converted laser beam is set. Both analog and digital electronic processes are known, which can be used for that purpose.

A further embodiment of the present invention is shown in FIG. 4. In this embodiment, it is possible to avoid undamped relaxation oscillations in the laser power.

A beam splitter 25 is used to deflect a part of the primary laser beam onto a detector 20. The power fluctuations in the primary laser beam in the frequency range of some Hz to some 10 MHz are converted by that detector 20 into an electrical signal which is fed to an electronic regulating arrangement 21. The electronic regulating arrangement 21 substantially includes a high-frequency amplifier with phase correction. The output signal of the electronic regulating arrangement 21 is added to the injection current for the laser diode 1 from the current supply device 22. The gain factor of the electronic regulating arrangement is so set that frequencies in the vicinity of the relaxation oscillation are optimally damped. That avoids undamped relaxation oscillations which can occur by virtue of backscatter effects 23 from the passive resonator 9.

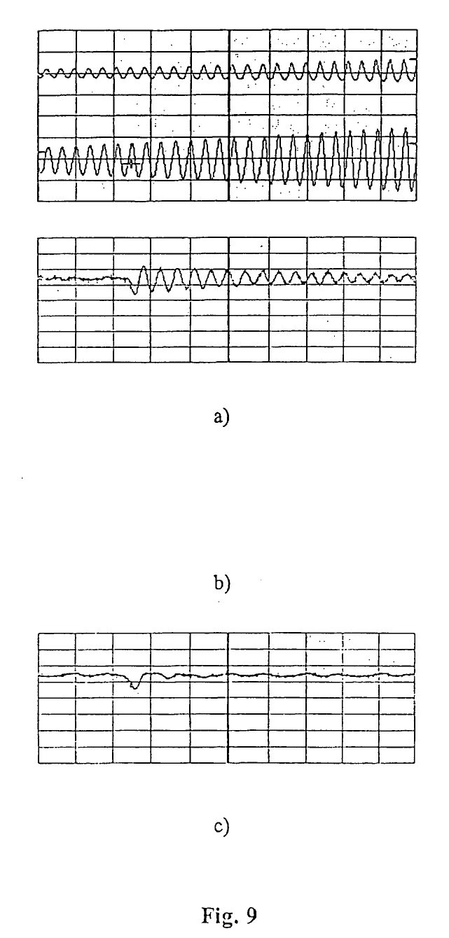

FIG. 9 shows oscilloscope recordings in respect of the power of the primary laser beam with a time deflection of 2 μs/scale portion. Curve a) shows the case of an undamped relaxation oscillation with coupled passive resonator. Curve b) shows a damped relaxation oscillation after a pulse-like disturbance in the laser diode current. In that case the passive resonator is blocked off and the regulation is shut down. In curve c) regulation is switched on and amplification is set to an optimum so that the relaxation oscillation is optimally damped. Upon coupling of the passive resonator no more undamped oscillations could now be observed.

The invention described in the embodiments by way of example makes it possible to provide a continuous, frequency-converted, optically pumped solid-state laser which has a high level of optical-optical overall efficiency and whose noise in the relevant frequency range below about 1 GHz is similarly low to the situation with a monomode laser, whose output power after the first frequency conversion stage is at least 300 mW and which is simpler and less expensive to produce than a monomode laser of comparable power.

A laser of that kind can be produced in particular by an optically pumped, active solid-state laser medium such as for example Nd:YAG or Nd:YVO₄ being arranged in the center of the laser resonator with two mirrors and using a frequency-selective element such as for example an etalon in the laser resonator so that precisely two adjacent longitudinal laser modes are formed and the primary laser beam which is coupled out of the laser resonator, with a fundamental wavelength, is converted in one or a plurality of external passive resonators with one or more non-linear crystals to a laser beam of a different wavelength. Control of the frequency-dependent elements in the laser resonator by means of regulating loops affords the possibility if required of permanently guaranteeing the two-mode operation and thus the desired laser properties.

The invention is not restricted to the embodiments described herein. Rather it is possible to implement further embodiments by a combination of the features.

1. A laser resonator (6) with an amplification medium (5) arranged therein and a frequency-selective element (4) which is arranged in the laser resonator and which has a frequency-dependent attenuation profile, wherein the frequency-selective element in respect of the frequency dependency of the attenuation profile and the laser resonator in respect of its optical length are adapted to be tunable in such a way that with an adjustable optical two-mode length of the laser resonator a primary laser beam with precisely two adjacent longitudinal laser modes can be coupled out of the laser resonator, characterized by
a first regulator which is adapted to control the optical length of the laser resonator in dependence on an input signal, or the first and additionally a second regulator which is adapted to control the attenuation profile of the frequency-selective element in dependence on an input signal, or a third regulator which is adapted to control both the optical length of the laser resonator and also the attenuation profile of the frequency-selective element in dependence on an input signal, wherein the input signal is dependent on the difference in the intensity of the two laser modes and the first, second or third regulator respectively is adapted to effect the control in such a way that the primary laser beam can be permanently coupled out with the same or with approximately the same intensity of the two laser modes.

2. A laser resonator as set forth in claim 1 wherein the first or the third regulator produces a control signal and outputs it to a first adjusting member which is adapted to change the temperature of the laser resonator (6).

3. A laser resonator as set forth in claim 2 wherein the first adjusting member is additionally adapted to change the temperature of the frequency-selective element (4).

4. A laser resonator as set forth in claim 1 wherein the second or the third regulator produces a control signal and outputs it to a second adjusting member which is adapted to change the temperature of the frequency-selective element (4).

5. (canceled)

6. A laser resonator as set forth claim 1 wherein the frequency-selective element is in the form of a birefringent filter or a combination of one or more etalons with a birefringent filter or is in the form of an etalon (4) or a combination of a plurality of etalons.

7. A laser resonator as set forth in claim 6 wherein at least one of the etalons is a coupling-out mirror (4) in the form of an etalon.

8. A laser resonator as set forth in claim 6 wherein at least one etalon (4) is in the form of an angle-tunable etalon.

9. A laser resonator as set forth in claim 6 wherein the amplification medium has an amplification profile with a center frequency ν₀ at which the amplification profile has a maximum and wherein with the optical two-mode length of the laser resonator the frequencies of the two adjacent longitudinal laser modes are symmetrical or approximately symmetrical around the center frequency ν₀.

10. A laser resonator as set forth in claim 6 wherein at least one etalon (4) has a frequency of minimum attenuation (preferred frequency) which is tunable to the center frequency ν₀ of the amplification profile and wherein the band width of the etalon (4) is so selected that only the two adjacent longitudinal laser modes are amplified in the laser resonator.

11. A laser resonator as set forth in claim 1 wherein the temperature dependency of the optical length of the laser resonator (6) and the temperature dependency of the preferred frequency of the frequency-selective element are such that permanent two-mode operation can be achieved solely by regulation of the common temperature of the laser resonator and the frequency-selective element.

12. A laser arrangement comprising a laser resonator as set forth in claim 1 and at least one external passive resonator (9) with a non-linear crystal (10) which is arranged and adapted to produce a secondary laser beam by frequency conversion of a primary laser beam (12) from the laser resonator (6).

13. A laser arrangement as set forth in claim 12 comprising a first measuring means which is adapted and arranged to produce and output a first measurement signal which is dependent either on the power or the intensity or the energy of the secondary laser beam.

14. A laser arrangement as set forth in claim 13 comprising an evaluation unit which is connected downstream of the first measuring means and which is adapted to output to the first, second or third regulator a fault signal which is dependent on the first measurement signal and which contains information about the direction and magnitude of a deviation of the adjusting parameter from an optimum setting.

15. A laser as set forth in claim 12 wherein the external passive resonator (9) is adapted for frequency doubling of the primary laser beam (12).

16. A laser arrangement as set forth in claim 12 wherein the optical length of the external passive resonator (9) is an integral multiple of the optical length of the laser resonator (6) or can be set to an integral multiple of the optical length of the laser resonator.

17. A laser arrangement as set forth in claim 12 which includes at least two successively connected external passive resonators (9, 15) in such a way that the primary laser beam (12) can be coupled into the first external passive resonator (9) and the frequency-converted secondary laser beam (13) from the first external passive resonator (9) can be coupled for further frequency conversion into the second external passive resonator (15).

18. A laser arrangement as set forth in claim 17 wherein the optical lengths of the external passive resonators (9, 15) are an integral multiple of the optical length of the laser resonator (6) or can be set to an integral multiple of the optical length of the laser resonator.

19. A laser arrangement as set forth in claim 18 wherein the optical length of the second external passive resonator (15) is set or can be set in such a way that it differs markedly from an integral multiple of the optical length of the laser resonator (6).

20. A laser arrangement as set forth in claim 19 wherein the second external passive resonator (15) includes an optical element which causes a change in the optical path length.

21. A laser arrangement as set forth in claim 12 which includes a pump light source (1) and a regulating circuit, wherein the regulating circuit has a detector (20) for detecting high-frequency power fluctuations of the primary laser beam (12) and an adjusting member for acting on the pump light source (1) in such a way that undamped oscillations in the laser power are suppressed.
